(19) United States
(12) Patent Application Publication
(10) Pub. No.: US 2024/0280230 A1
(43) Pub. Date: Aug. 22, 2024

(54) OVERHEAD CROSSWALK LIGHTING ARRANGEMENT

(71) Applicant: John McGaffey, Greenville, TX (US)

(72) Inventor: John McGaffey, Greenville, TX (US)

(73) Assignee: Polara Enterprises, LLC, Greenville, TX (US)

(21) Appl. No.: 18/111,505

(22) Filed: Feb. 17, 2023

(51) Int. Cl. F21S 8/04; F21V 7/00

(52) U.S. Cl. CPC F21S 8/043; F21V 7/0066; F21W 2111/023

(57) ABSTRACT

A crosswalk lighting arrangement is provided. The arrangement includes a light source, securing hardware configured to secure the light source above a position between the center line of the crosswalk and a predetermined position in the direction of oncoming traffic and at a predetermined height above the crosswalk, and protective shielding configured to block and direct light energy from the light source to a predetermined range relative to the crosswalk forward border and the crosswalk rear border. The light source generates light energy at a minimum of 30 lux of vertical luminance.

### BACKGROUND OF THE INVENTION

### Field of the Invention

The present disclosure relates generally to the field of lighting devices, and more specifically to lighting employed over roadways where vehicles traverse and crosswalks are provided.

### Description of the Related Art

Most metropolitan areas in the United States and elsewhere have intersections controlled by traffic lights. Such intersections, as well as mid-street crosswalks, are typically equipped with pedestrian push buttons that are physically pushed to activate Walk/Don't Walk signals or non-verbal symbols displayed in a pedestrian signal head, also referred to as a ped head, to visually indicate when the vehicular traffic is signaled to stop, such that a Walk phase is in effect. During a Walk phase, a traffic controller provided at an intersection signals the traffic signals to direct traffic to stop and the ped head displays the walk signal for the particular crosswalk for a predetermined period of time. In a non-intersection situation, crossing mid-block, the pedestrian initiates a Walk signal and some type of indication, such as lighted indicators provided in or on the side of the street for oncoming drivers, light up indicating the crosswalk is in use and oncoming traffic must stop.

Pedestrians crossing a street at night via a crosswalk can face various risks. If the pedestrian is wearing dark clothing at night, he or she can be at increased risk. Further, a vehicle operator failing to exercise due care while driving at night may accidently strike a pedestrian in a crosswalk. Lighting conditions are sometimes sporadic, spaced improperly or faulty, which can endanger the pedestrian. Additionally, while the pedestrian can initiate a Walk signal and crosswalks can include Walk indicator lights, street level illuminators, such as flashing lights, or other indications the crosswalk is in use, inattentive drivers or those traveling at excess speeds can present a significant danger to a pedestrian who believes he or she has the right of way. Persons who slowly traverse crosswalks in darkness can also be at increased risk. Other issues include absence or failure of adequate street lighting, further putting pedestrians at risk to oncoming traffic.

Certain designs are available that can reduce these types of risks, such as increasing the amount of time allowed for persons to cross or providing better lighting in a dark area.

It may be beneficial to offer a type of design that reduces pedestrian risks associated with crosswalks, particularly in dark situations. A design that alerts drivers to the presence of pedestrians over currently available designs would be beneficial.

### SUMMARY OF THE INVENTION

Thus according to one embodiment, there is provided a crosswalk lighting arrangement positioned relative to a crosswalk having a first border, a second border, and a center line, the crosswalk lighting arrangement comprising a light source, securing hardware configured to secure the light source above a position between the center line of the crosswalk and a predetermined position in the direction of oncoming traffic and at a predetermined height above the crosswalk, and protective shielding provided with and extending downward from the light source that directs light energy from the light source to a predetermined range relative to the crosswalk first border and the crosswalk second border. The light source generates light energy at a minimum of 30 lux of vertical luminance.

According to a further embodiment, there is provided a crosswalk lighting arrangement positioned above a crosswalk having a forward border, a rear border, and a center line, the crosswalk lighting arrangement comprising a light source, securing hardware configured to secure the light source above a position between the center line of the crosswalk and a predetermined position in the direction of oncoming traffic and at a predetermined height above the crosswalk, and protective shielding configured to block and direct light energy from the light source to a predetermined range relative to the crosswalk forward border and the crosswalk rear border. The light source generates light energy at a minimum of 30 lux of vertical luminance.

According to another embodiment, there is provided a crosswalk lighting arrangement positioned above a crosswalk having a forward border, a rear border, and a center line, the crosswalk lighting arrangement comprising a light source positioned above a lane of traffic, securing hardware configured to secure the light source above a position between the center line of the crosswalk and a predetermined position in the lane of traffic and at a predetermined height above the crosswalk, and protective shielding configured to block and direct light energy from the light source to a predetermined range relative to the crosswalk forward border and the crosswalk rear border. The light source generates light energy at a minimum of 30 lux of vertical luminance.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 illustrates a general overview of a typical street including a mid-block crosswalk;

FIG. 2 illustrates a typical lighting installation where lighting is provided according to the present design;

FIG. 3 illustrates a sample light source;

FIG. 4 is a general representation of one embodiment of electronics employable with the present design;

FIG. 5 shows an alternate embodiment of a light source and

FIGS. 6A through 6C illustrate various light source representations positioned at different orientations relative to a crosswalk.

### DETAILED DESCRIPTION

The present disclosure is not limited to the details or methodology set forth in the description or illustrated in the figures. Terminology used herein is for the purpose of description only and should not be regarded as limiting.

The present disclosure is directed to an advanced lighting system that increases visibility of pedestrians in a crosswalk and is particularly beneficial at nighttime. The system consists of a lighting arrangement having particular performance attributes and positioning with respect to the crosswalk such that light energy reflects off the pedestrian at a beneficial angle and light level.

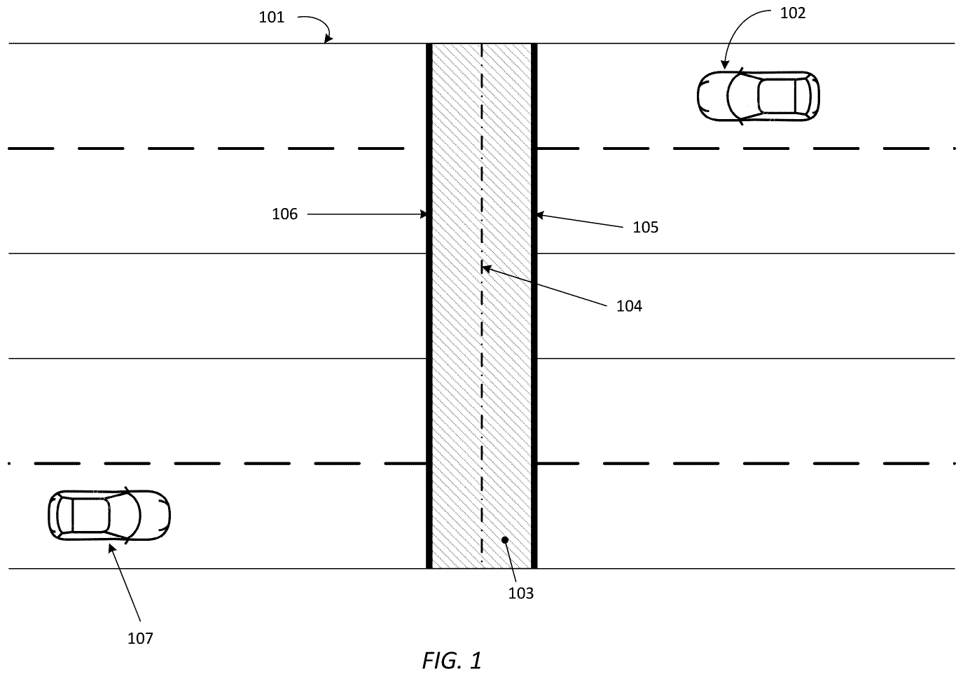

FIG. 1 illustrates a general overhead view of a typical street including a crosswalk. FIG. 1 illustrates a typical roadway, but as discussed herein, the system provided may be employed in an intersection having up to four crosswalks. Curb line 101 is provided, with vehicle 102 moving toward crosswalk 103 having crosswalk centerline 104. Crosswalk forward border 105 is the boundary of the crosswalk in the direction of oncoming traffic, while crosswalk rear border 106 is the boundary of the crosswalk away from the direction of oncoming traffic. Such terminology may be reversed when reference is made to crosswalk boundaries in the opposite direction of traffic. Also illustrated is vehicle 107 traveling in the opposite direction of vehicle 102.

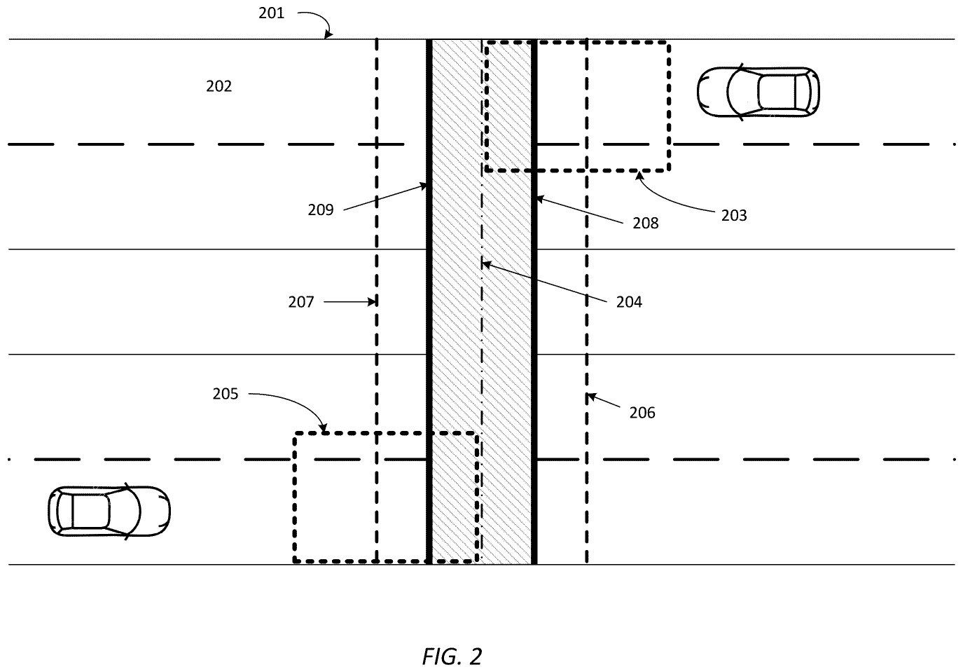

FIG. 2 is similar to FIG. 1 and illustrates a typical lighting installation according to the present design. The lighting fixture in the right lane 202, the uppermost lane in FIG. 2, is positioned within zone 203, or above zone 203, where zone 203 is inward from curb line 201 and away from or to the left of center line 204. Zone 203 may extend a particular distance into the oncoming lane, in one instance 25 feet from the center line 204 of the crosswalk, but in other instances greater or smaller distances may be provided, such as approximately zero, 5, 10, 15, 20, 30, 35 or 40 feet from the center line 204 of the crosswalk. From FIG. 2, the lateral distance shown may be the same for all lanes provided, or in other words lighting sources or lighting fixtures may be provided in each lane anywhere from the center line 204 to the prescribed distance discussed. A similar zone 205 is shown in FIG. 2, where zone 205 is dimensioned similar or identical to zone 203. The width of the zone, such as zone 203 or zone 205, may vary and may in some instances pass the curb line and in other instances extend into an adjacent lane, and thus the width of zones 203 and 205, for example, may vary depending upon installation circumstances.

Irrespective of the position(s) where light source(s) or fixture(s) are mounted within or above zone 203, light borders 206 and 207 represent one embodiment of maximum light projection beyond the crosswalk borders or crosswalk lines 208 and 209. Light energy from the lighting hardware may in one embodiment be projected between light borders 206 and 207.

The light source may be installed on a mast arm or on any type of overhang that positions the light source within the boundaries of zone 203 and zone 205 in the representations of FIG. 2. A light source may be positioned above a single approach lane or between lanes if two or more lanes are provided in the same direction. In one embodiment, the light source may be provided a level above the crosswalk such as at a position between fifteen and 25 feet above ground.

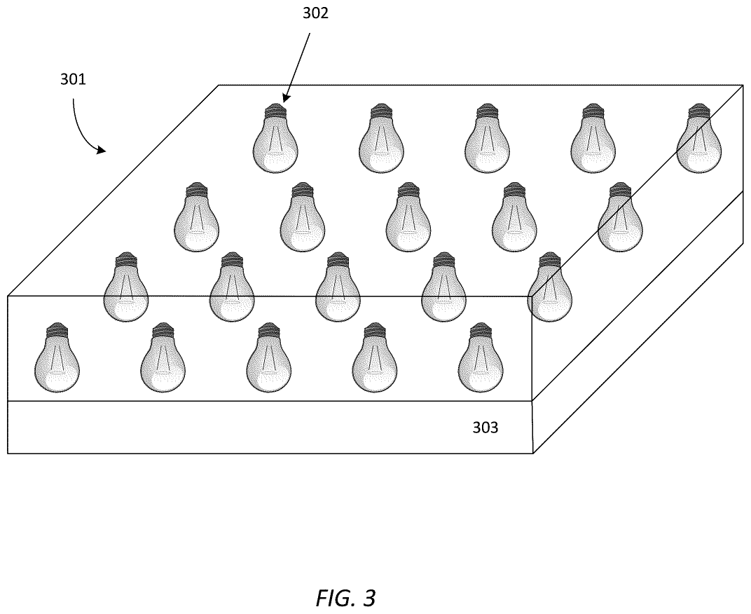

FIG. 3 illustrates a sample light source 301 comprising illuminators including illuminator 302, which may be any type of illuminating devices including but not limited to LED lights, incandescent lights, halogen lights, and CFL lights. Each light source, such as light source 301, is provided with protective shielding 303 that is dimensioned for the anticipated deployment such that light distribution is limited to a distance beyond each crosswalk line in the direction of oncoming traffic, such as crosswalk line 105. In one embodiment, light energy is limited by protective shielding 303 to be no greater than a predetermined value such as 1, 5, or 10 feet in front of the crosswalk line in the direction of oncoming traffic, shown as light border 206 in FIG. 2 in the case of uppermost right lane 202. Illumination in both directions, as a result of the protective shielding 303, limits all light illumination to a distance of five feet from a crosswalk line such as crosswalk line 208, resulting in a lighted zone having a total width of 10 feet greater than the width of crosswalk 103. Shielding 303 may be adjustable such that during installation the shielding 303 may be adjusted to achieve a desired lighting zone.

Employing a light source such as light source 301 prevents drivers from seeing the light source from their normal approach in either lane in the flow of traffic, allowing the light source to be of significant intensity. Drivers approaching the light source can, in one embodiment, not be impacted or visually encounter light until within 25 feet of the crosswalk, but this measurement is very geometry dependent. If the light source is positioned higher or lower and/or has differently dimensioned protective shielding, the measurement value may be different, from a number of less than 10 feet to over 50 or 100 feet. Such positioning of light source 301 prevents the light emitted from producing glare in the oncoming driver's eyes. However, this positioning increases the illumination of the crosswalk.

In one embodiment, the light is always on after dark, i.e., using a light sensor that senses a predetermined level of darkness wherein exceeding a threshold causes the light to be illuminated. In another embodiment, the light source is illuminated only when the pedestrian pushes a button, while in a further embodiment a motion sensor is provided such that the crosswalk is illuminated when a vehicle is approaching and turns off after the vehicle has passed by the crosswalk.

Light energy may vary, and in one instance, it can be beneficial to provide a vertical luminance level of 20 Lux in the crosswalk, measured a distance above the crosswalk, such as 1 meter, 1.5 meters, or 2 meters or more above the crosswalk. In one embodiment the light source generates a minimum of 30 lux of vertical luminance within the crosswalk and up to 120 lux or greater if strobed. In another embodiment, the light source generates a minimum of 20 lux of vertical luminance within the crosswalk when measured at a height of approximately or exactly 1.5 meters or 5 feet. Light can be any color, including any temperature of white light, but other colors and/or combinations of colors may be employed. Light energy may be strobed to enhance reflection from the pedestrian and/or his or her clothing. If the system employs multiple colors, each color may be projected in parallel or in sequence to enhance reflectivity from a pedestrian. Lighting provided by a series of lights may be fixed in place or may rotate. In such an arrangement, each light or light bulb provided in light source 301 may be individually rotatable.

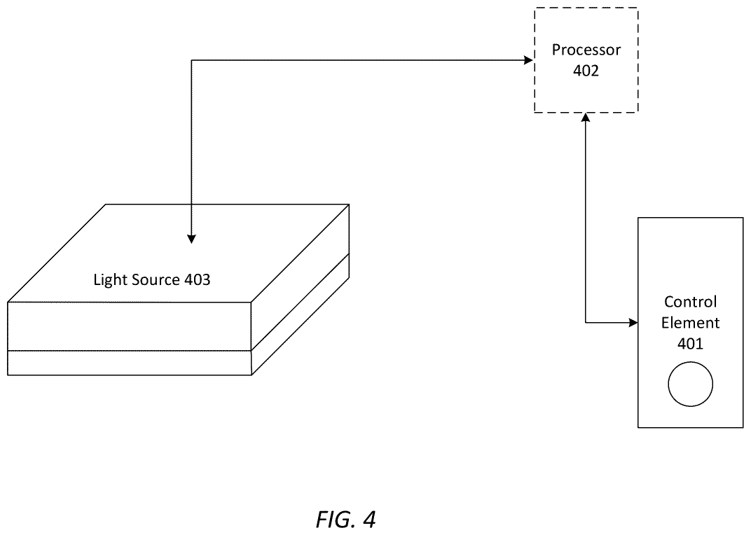

FIG. 4 is a general representation of an embodiment the electronics that may be employed with the present design. While a single light source is shown, the electronics may be used to control multiple light sources in multiple lanes. Control element 401 may be a pedestrian initiated pushbutton switch or may be a sensor, including but not limited to a motion sensor determining the presence of a pedestrian, a motion sensor determining the presence of an approaching vehicle, a light sensor determining a level of ambient light, a timer, or any other device that determines or is used to determine the need for providing light above the crosswalk. Processor 402 is optional and may be any type of processing element configured to receive signals from control element 401 and may signal the light source 403 to illuminate. Any type of processing device, software, and/or hardware may be employed, including ASICs, microprocessors, and so forth. Lighting from the light source 403 may also be turned off based on signals from processor 402, which may include a clock or timer function wherein the crosswalk is illuminated for a predetermined amount of time. Processing may be performed by processor 402 which may be incorporated into control element 401 or light source 403. Alternately, simple sensing by control element 401 may cause illumination of light source 403, i.e. a direct connection may be provided between control element 401 and light source 403 with little or no processing.

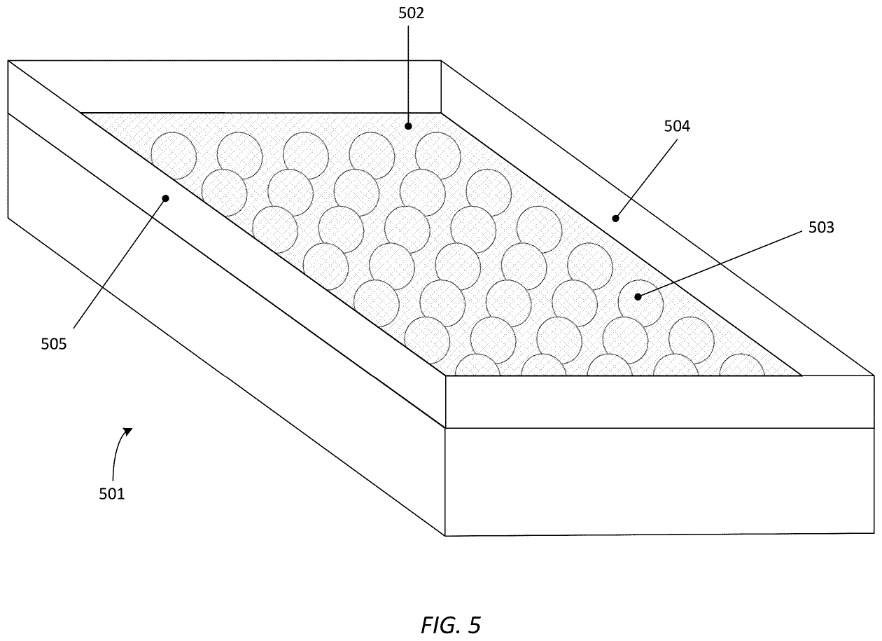

FIG. 5 shows an alternate embodiment of a light source that may be employed in the current design. From FIG. 5, light source 501 is generally rectangular in shape and includes a protective sheet 502 that may be made from plexiglass or other appropriate material. Lights in this embodiment are LED lights including LED light 503, arranged in this embodiment in multiple rows. The individual lights may be angled as desired to adhere to the lighting limitations relative to the crosswalk, i.e. such that light illuminates a space X feet in front of and X feet behind the crosswalk. If desired, the illumination at the back line of the crosswalk may differ in distance as compared to the front line of the crosswalk, with front line being in the direction of oncoming traffic and back line opposite the direction of oncoming traffic. Light may be projected to a line X feet in front of the front line of the crosswalk and Y feet behind the back line of the crosswalk.

Also shown in FIG. 5 is front protective shielding 504 and rear protective shielding 505 as well as optional protective side shielding. The protective shielding serves two purposes. First, front protective shielding 504 protects the oncoming drivers from excessive light, and the rear protective shielding 505 protects drivers in the opposite lane, traveling in the opposite direction, from excessive light. Secondly, both protective shieldings, as well as any on the side(s), serve to direct light energy in a desired direction with respect to the crosswalk. Protective shieldings may take any desired form or dimension and in some instances may be adjustable about an axis or hinge. Further, while not shown in this representation, the entire light source 501 may be rotated to direct light energy in a desired direction, again to a desired orientation with respect to the crosswalk in accordance with the teachings disclosed herein.

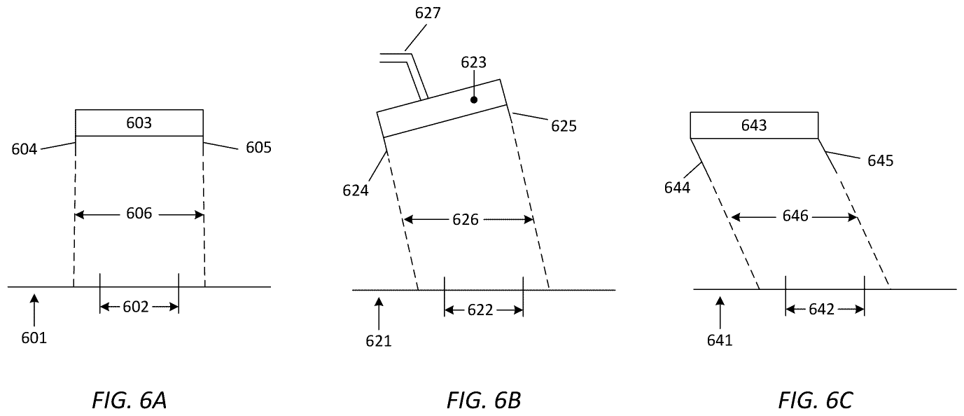

FIGS. 6A through 6C illustrate various light source representations positioned at different orientations relative to a crosswalk. In FIG. 6A, crosswalk 602 in roadway 601 is illuminated by light source 603 comprising protective shieldings 604 and 605. Crosswalk 602 is shown in a side view, i.e., the edges marked facing traffic. Light energy 606 is directed downward and potentially outward to contact the crosswalk as shown. Protective shieldings may be reflective or partially reflective and other mirrors or reflective/partially reflective surfaces may be provided to direct the light energy 606 in a desired direction.

FIG. 6B shows an offset orientation with roadway 621 having crosswalk 622 where light source 623 is angled and joined with mast or mast arm 627, which may enable rotation of light source 623 to a desired angle. Protective shieldings 624 and 625 are shown. Light energy 626 is directed at an angle as shown, striking the road at points in front of and behind the crosswalk in this rotated light source configuration.

FIG. 6C illustrates an offset light source 643. Such a condition, the light source being offset from the crosswalk, may occur in different situations, such as where the light source is attached to an existing piece of equipment or overhang. In this situation, crosswalk 642 is located within street 641, and offset light source 643 employs two relatively large protective shieldings 644 and 645. These shieldings serve to direct the light in a desired direction and generally include reflective or at least partially reflective inner surfaces. Protective shieldings cannot extend downward to interfere with vehicles, i.e. must conform to height standards and requirements, such as DOT and state standards. When light source 643 is on, light energy 646 is emitted in the direction shown.

Note that in all drawings presented herein, including the representations of the light source or sources, are not to scale, and different dimensions for all components provided may be provided.

Thus according to one embodiment, there is provided a crosswalk lighting arrangement positioned relative to a crosswalk having a first border, a second border, and a center line, the crosswalk lighting arrangement comprising a light source, securing hardware configured to secure the light source above a position between the center line of the crosswalk and a predetermined position in the direction of oncoming traffic and at a predetermined height above the crosswalk, and protective shielding provided with and extending downward from the light source that directs light energy from the light source to a predetermined range relative to the crosswalk first border and the crosswalk second border. The light source generates light energy at a minimum of 30 lux of vertical luminance.

According to a further embodiment, there is provided a crosswalk lighting arrangement positioned above a crosswalk having a forward border, a rear border, and a center line, the crosswalk lighting arrangement comprising a light source, securing hardware configured to secure the light source above a position between the center line of the crosswalk and a predetermined position in the direction of oncoming traffic and at a predetermined height above the crosswalk, and protective shielding configured to block and direct light energy from the light source to a predetermined range relative to the crosswalk forward border and the crosswalk rear border. The light source generates light energy at a minimum of 30 lux of vertical luminance.

According to another embodiment, there is provided a crosswalk lighting arrangement positioned above a crosswalk having a forward border, a rear border, and a center line, the crosswalk lighting arrangement comprising a light source positioned above a lane of traffic, securing hardware configured to secure the light source above a position between the center line of the crosswalk and a predetermined position in the lane of traffic and at a predetermined height above the crosswalk, and protective shielding configured to block and direct light energy from the light source to a predetermined range relative to the crosswalk forward border and the crosswalk rear border. The light source generates light energy at a minimum of 30 lux of vertical luminance.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the embodiments of the crosswalk lighting arrangement as shown in the various exemplary embodiments is illustrative only. Additionally, any element disclosed in one embodiment may be incorporated or utilized with any other embodiment disclosed herein.

What is claimed is:

1. A crosswalk lighting arrangement positioned relative to a crosswalk having a first border, a second border, and a center line, the crosswalk lighting arrangement comprising:
a light source;
securing hardware configured to secure the light source above a position between the center line of the crosswalk and a predetermined position in the direction of oncoming traffic and at a predetermined height above the crosswalk; and
protective shielding provided with and extending downward from the light source that directs light energy from the light source to a predetermined range relative to the crosswalk first border and the crosswalk second border;
wherein the light source generates light energy at a minimum of 30 Lux of vertical luminance.

2. The crosswalk lighting arrangement of claim 1, wherein the light source is configured to strobe at a value less than 120 lux.

3. The crosswalk lighting arrangement of claim 1, wherein the protective shielding is at least partially reflective.

4. The crosswalk lighting arrangement of claim 1, wherein the securing hardware comprises a mast arm.

5. The crosswalk lighting arrangement of claim 1, wherein the predetermined position in the direction of oncoming traffic is between zero and 40 feet from the center line and the predetermined height is between 15 and 25 feet.

6. The crosswalk lighting arrangement of claim 1, wherein the light source employs a plurality of lights comprising an LED light, a halogen light, or a CFL light.

7. The crosswalk lighting arrangement of claim 1, wherein the light source is provided at an angle nonparallel to the crosswalk.

8. A crosswalk lighting arrangement positioned above a crosswalk having a forward border, a rear border, and a center line, the crosswalk lighting arrangement comprising:
a light source;
securing hardware configured to secure the light source above a position between the center line of the crosswalk and a predetermined position in the direction of oncoming traffic and at a predetermined height above the crosswalk; and
protective shielding configured to block and direct light energy from the light source to a predetermined range relative to the crosswalk forward border and the crosswalk rear border;
wherein the light source generates light energy at a minimum of 30 lux of vertical luminance.

9. The crosswalk lighting arrangement of claim 8 wherein the light source is configured to strobe at a value less than 120 lux.

10. The crosswalk lighting arrangement of claim 8, wherein the protective shielding is positionally adjustable.

11. The crosswalk lighting arrangement of claim 8, wherein the securing hardware comprises a mast arm.

12. The crosswalk lighting arrangement of claim 8, wherein the predetermined position in the direction of oncoming traffic is between zero and 40 feet from the center line and the predetermined height is between 15 and 25 feet.

13. The crosswalk lighting arrangement of claim 8, wherein the light source employs a plurality of lights comprising an LED light, a halogen light, or a CFL light.

14. The crosswalk lighting arrangement of claim 8, wherein the light source is provided at an angle nonparallel to the crosswalk.

15. A crosswalk lighting arrangement positioned above a crosswalk having a forward border, a rear border, and a center line, the crosswalk lighting arrangement comprising:
a light source positioned above a lane of traffic;
securing hardware configured to secure the light source above a position between the center line of the crosswalk and a predetermined position in the lane of traffic and at a predetermined height above the crosswalk; and
protective shielding configured to block and direct light energy from the light source to a predetermined range relative to the crosswalk forward border and the crosswalk rear border;
wherein the light source generates light energy at a minimum of 30 lux of vertical luminance.

16. The crosswalk lighting arrangement of claim 15 wherein the light source is configured to strobe at a value less than 120 lux.

17. The crosswalk lighting arrangement of claim 16, wherein the light source employs more than one color of lighting.

18. The crosswalk lighting arrangement of claim 15, wherein the predetermined position in the lane of traffic is between zero and 40 feet from the center line and the predetermined height is between 15 and 25 feet.

19. The crosswalk lighting arrangement of claim 15, wherein the light source employs a plurality of lights comprising an LED light, a halogen light, or a CFL light.

20. The crosswalk lighting arrangement of claim 15, wherein the light source is provided at an angle nonparallel to the crosswalk.
